(19) United States
(12) Patent Application Publication
(10) Pub. No.: US 2010/0115776 A1
(43) Pub. Date: May 13, 2010

(54) Manual Can Opener Tool

(75) Inventors: Wu Zi He, Rome, NY (US); Yue Sai Zheng, Rome, NY (US)

Correspondence Address: BERNHARD P. MOLLDREM, JR., 224 HARRISON STREET, SUITE 200, SYRACUSE, NY, 13202, US

(73) Assignee: Ait Innovations, Inc.

(21) Appl. No.: 12/266,584

(22) Filed: Nov. 7, 2008

(51) Int. Cl. B67B 7/54; B23P 19/02

(52) U.S. Cl. 30/439; 29/426.4

(57) ABSTRACT

A manual can opener tool is formed of a handle, a shaft that has a proximal end secured to the handle, a piercing spear point, i.e., spade at the distal end of the shaft, and a generally triangular cutting knife that is mounted on the shaft and can be adjusted in axial position on the shaft. The tool is used by piercing the center of a can lid with the spear point, rotating the tool down so that the cutting knife pierces the can lid near the rim of the can, and then pulling or pushing the tool in a circle, using the spear point as a fulcrum, to make an arcuate cut in the lid. The tool does not require manipulating a crank, and the tool is also used to lift the lid off the can.

### BACKGROUND OF THE INVENTION

This invention relates to a hand-operated can opener of simple design, and which does not rely on cranks or gears. The invention is more particularly directed to a hand-held implement for opening a steel can or the like. The invention is especially concerned with a can opener device with a minimum of moving parts, which can be easily adjusted to the size of the can, and which can quickly cut and remove the lid, with either right-handed or left-handed operation, and without relying on the user having to manipulate a twist handle or crank.

Currently, portable hand-held can openers require a gripping device that clamps onto the rim of the can, and to move the can when a crank handle is rotated. A knife that is a part of the opener penetrates the can lid near the rim, and makes a circular cut through the rim when the can is rotated.

The openers of this type tend to be bulky and have moving parts, typically including a gear drive and a clamp to grasp the rim of he can. These items can wear and can fail. Moreover, some persons, including the elderly and those who experience joint pain, can find it difficult to work the crank handle or winder of the device, or to work the clamp portion.

Accordingly, there is a need for a simple can opener device that has a minimal number of moving parts, and which does not require the user to manipulate a winder or crank.

### OBJECTS AND SUMMARY OF THE INVENTION

It is an object of the present invention to provide a can opener device of simple construction which overcomes the drawbacks of the prior art.

It is another object to provide a can opener that is simple to use and can open the lid of the can in either direction.

A further object is to provide a can opener device which is small and portable, and which can be easily used by any person.

According to one aspect of the invention, a manual can opener, for cutting through the can's metal lid is in the form of a tool having an elongated shaft with a proximal end, a distal end, and a profile with at least one non-circular portion adapted to serve as a keyway so that the shaft is blocked against rotation. A handle is mounted onto the proximal end of the shaft, and there is a piercing spear point at the distal end of the shaft. A generally triangular cutting knife is carried on the shaft and can slide along the shaft, so that its position along the shaft can be adjusted. The cutting knife, which is favorably a plate of steel, has a distal face and a proximal face, and a pair of side walls that are tapered from the distal face to the proximal face to form cutting edges. These side walls meet to form a vertex or point that is oriented down, i.e., towards the can lid. There is a shaped passage through the cutting knife, and the passage has a keyed profile that mates with the shaft. Thus, the shaft passes through the passage, and while the cutting knife can be slideably adjusted in position along the shaft, the knife is blocked from rotation about the shaft, and is held so that the vertex remains oriented at one predetermined side of the shaft.

Favorably, the cutting knife is in the form of a triangular steel member having a thickness of between 1 mm and 2 mm, preferably about ⅛ cm.

The shaft may have a square profile, hexagonal profile, or another polygonal profile, and the passage can have a matching square, hexagonal or other polygonal shape.

The spear point is favorably in the form of a flattened pointed spade member, and the distal end of the shaft can have an offset that joins the spade member and displaces it to the one predetermined side of the shaft, i.e., the same direction as the vertex of the cutter blade.

The method of manually opening a can may be carried out, using the above-described can opener tool, as follows: The user holds the handle end in his or her hand, and places the spear point of the can opener at a center point of the lid. Then the user pushes the opener against the can lid to pierce the lid at the center point. The position of the cutting knife along the shaft is adjusted, as needed, so that the point or vertex of the cutter blade will come down near the rim of the can. The user rotates the opener downward, using the spear point as a fulcrum, until the vertex of the cutting knife penetrates the can lid, rotating the opener about a vertical axis of the can to cut the can lid.

The above and other features and advantages of the can opener tool of this invention will become apparent from the ensuing description of a preferred embodiment, which is to be read in conjunction with the accompanying Drawing figures.

### BRIEF DESCRIPTION OF THE DRAWING

FIG. 1 is a perspective view of a can opener tool according to one embodiment of this invention.

FIG. 2A shows the distal end of the shaft and piercing spear point thereof.

FIG. 2B shows a central port of the shaft and cutting knife thereof.

FIG. 2C is a plan view of the cutting knife taken at line 2C-2C of FIG. 2B.

FIG. 2D is an edge-on view of the cutter knife taken at line 2D-2D of FIG. 2C.

FIG. 3 and FIG. 4 are perspective views for explaining the operation of the can opener tool of this embodiment.

### DETAILED DESCRIPTION OF THE PREFERRED EMBODIMENT

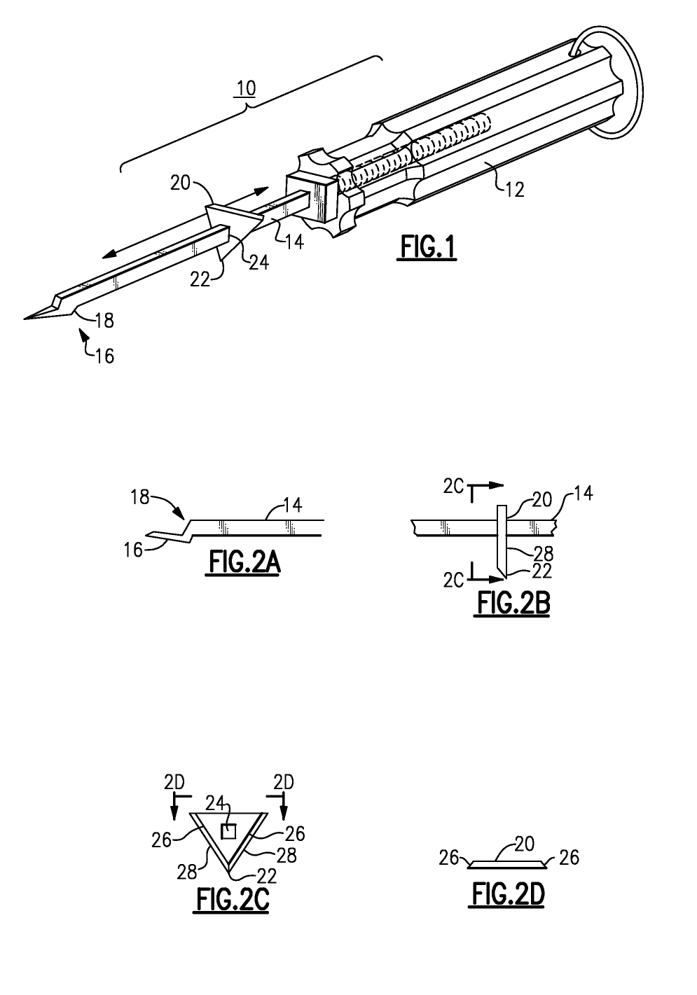

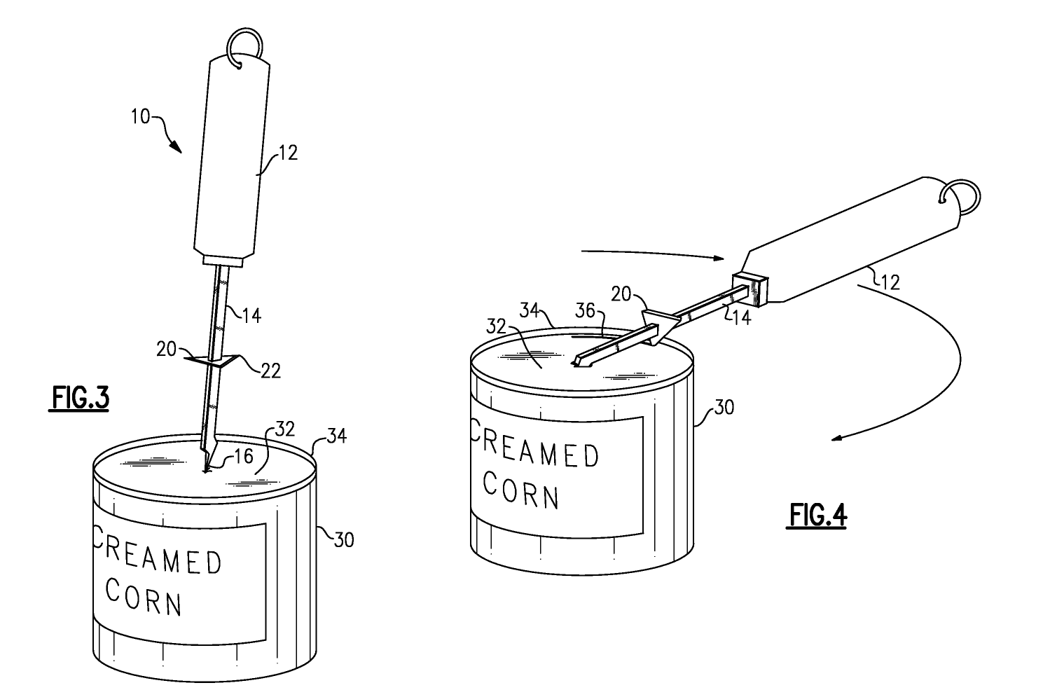

With reference to the Drawing, FIG. 1 and FIGS. 2A to 2D illustrate the can opener tool 10 of an embodiment of this invention.

As shown in FIG. 1, the tool 10 has a handle 12, which can be molded of a suitable durable plastic material. This handle is favorably about 11 cm long and about 2.5 cm wide, e.g., similar to a conventional screwdriver handle. An elongated steel shaft 14 has its proximal end embedded into the handle 12, and the shaft projects out about 9 cm to 10 cm to a distal end. The shaft 14 in this embodiment is a square steel shaft, about ½ cm on a side. The shaft can have a different profile, e.g., hexagonal or even round with some non-circular keyway formed in it, if preferred.

A piercing head 16 is formed at the distal end of the shaft 14. Here this head 16 is a flat, spade-like, i.e., generally triangular spearhead, with a pointed tip. There is an offset 18 at the end joining the piercing head 16 to the distal end of the shaft, and displacing the head to one predetermined side of the shaft 14, i.e., below the lower side of the shaft in this illustration.

A cutter blade 20, which is a generally triangular flat steel plate, is mounted on the shaft 14 and is free to slide along at least a portion of the shaft between the handle 12 and the piercing head 16. As shown more specifically in FIGS. 2C and 2D, the cutter blade has a point or apex 22, also oriented in the direction that is downward in these views, below the lower side of the shaft 14, i.e., the same direction as the offset 18. There is a square opening 24 at or near the center of the cutter blade, forming a passage for the shaft 14 with a profile that matches the profile of the shaft. This allows the cutter blade 20 the freedom to slide along the shaft, but blocks it from rotating about the axis of the shaft.

The triangular cutter blade 20 has side walls 26 that are tapered from one side to the other, i.e., between the proximal and distal surfaces, so that they the side wall meets one of these, e.g., the proximal wall, at acute angle to form a sharp cutting edges 28. The two side walls 26 angle toward another and meet at the lower point or vertex 22. The cutter blade does not have to be a triangle but should have symmetry so that the vertex or point 22 can penetrate the can lid near the rim of the can, and so that the blade can cut in either direction. In this embodiment, the cutter blade is a triangular plate about 19 mm on a side, and has a thickness of about 1.2 mm. In other favorable embodiments, the cutter blade may have a thickness of between 1 and 2 mm.

The process for opening a steel can, e.g., a sealed container of a consumable food material, will now be described with reference to FIGS. 3 and 4.

The typical steel can 30 has a generally cylindrical side wall, and a lid 32 in the form of a disk of sheet steel, joined to the side wall at a rolled rim 34. It should be noted that the method can be used with cans of oval or other non-circular profile, without much difficulty, but for purposes of simplicity this example shows a can 30 of round profile.

The user first picks up the opener tool 10 by the handle 12, and places the spear point 16 at the center of the lid 32, as shown in FIG. 3. Then, the user presses down, and the spear point 16 penetrates the lid 32 at the center. The user rotates the tool downward, using the spear point against the center hole formed in the lid as a fulcrum, and brings the handle down to the position shown in FIG. 4. The position of the cutter knife 20 along the shaft 14 is adjusted, as need be, so that the apex or point 22 of the cutter blade is on the can lid 32 adjacent the rim 34 of the can. Then the user presses down on the handle 12, and by lever action penetrates the metal of the can lid 32 with the cutter knife 20. Then the user pulls (or pushes) the handle 12, and moves the tool 10 in a circle about the center of the can lid 32, where the head 16 serves as a fulcrum. Here, the offset 18 on the shaft rests against the metal edge of the center hole in the lid. The user rotates the tool 10 around the can, in either direction, to form an arcuate cut 36 as seen in FIG. 4. Then the lid can be bent up, or removed, as desired. The tool 10 prevents the lid 32 from falling into the can 30, so that any dust or other material on the top surface of the lid 32 is prevented from contaminating the can's contents. The lid can be lifted off the can with the tool, and the lid remains on the shaft 14 of the tool until it is pushed off. This means that the user does not need to grasp the can lid with his or her hand, and there is no risk of injury to the hand from the sharp cut edge of the can lid 32.

As mentioned before, this embodiment is given as an example, and there are many possible variants of the can opener tool. The knife 20 can be of a different shape, and does not need to be strictly triangular. The shaft 14 shown here has a square profile, but in other embodiments, the shaft could have a different cross section, such as hexagonal or another polygon, so long as there is at least one non-circular portion that can serve as a keyway against rotation on the shaft. In this embodiment, the handle 12 is a molded plastic handle, but in other embodiments, the handle may be unitarily formed with the shaft 14. The cutting knife 20 can have a two-part construction, instead of the single-piece construction shown here. The piercing head and offset can have other shapes, while still serving the same function.

While the invention has been described with reference to one embodiment, it should be recognized that the invention is not limited to that precise embodiment. Rather, many modifications and variations will be apparent to persons skilled in the art without departing from the scope and spirit of this invention, as defined in the appended claims

I claim:

1. A manual can opener adapted for cutting through a metal lid of a can, wherein the can has a generally cylindrical wall, and the metal lid is sealably joined at a rim to said generally cylindrical wall, the can opener comprising:
an elongated shaft having a proximal end, a distal end, and a profile with at least one non-circular portion adapted to serve as a keyway against rotation of the shaft;
a handle mounted onto the proximal end of the shaft;
a piercing spear point at the distal end of the shaft; and
a cutting knife carried on said shaft and being slideable along said shaft, the cutting knife having a distal face and a proximal face; a pair of side walls that are tapered from the distal face to the proximal face to form cutting edges, and which meet to form a vertex; and a passage therethrough having a keyed profile that mates with said shaft, and with the shaft passing through said passage, such that the cutting knife can be slideably adjusted in position along said shaft but is blocked from rotation about the shaft, and such that said vertex is oriented at one predetermined side of said shaft.

2. The can opener of claim 1, wherein said cutting knife is in the form of a triangular steel member having a thickness of between 1 mm and 2 mm.

3. The can opener of claim 1, wherein said shaft has a polygonal profile, and said passage has a matching polygonal shape.

4. The can opener of claim 1, wherein said spear point is in the form of a flattened pointed spade member.

5. The can opener of claim 1, wherein comprising an offset joining the spade member to said one predetermined side of said shaft at the distal end thereof.

6. A method of manually opening can by cutting through a metal lid of the can, wherein the can has a generally cylindrical wall, and wherein the metal lid is sealably joined at a rim to said generally cylindrical wall; and wherein the can opener is in the form of a hand-held device that comprises:
an elongated shaft having a proximal end, a distal end, and a profile with at least one non-circular portion adapted to serve as a keyway against rotation of the shaft;
a handle mounted onto the proximal end of the shaft;
a piercing spear point at the distal end of the shaft; and
a cutting knife carried on said shaft and being slideable along said shaft, the cutting knife having a distal face and a proximal face; a pair of side walls that are tapered from the distal face to the proximal face to form cutting edges, and which meet to form a vertex; and a passage therethrough having a keyed profile that mates with said shaft, and with the shaft passing through said passage, such that the cutting knife can be slideably adjusted in position along said shaft but is blocked from rotation about the shaft, and such that said vertex is oriented at one predetermined side of said shaft; and wherein the method comprises:
a. placing the spear point of the can opener at a center point of the lid;
b. pushing the opener against the can lid to pierce the lid at the center point;
c. adjusting the position of the cutting knife along said shaft;
d. rotating the opener downward, using the spear point as a fulcrum, until the vertex of said cutting knife penetrates the can lid; and
e. rotating the opener about a vertical axis of the can to cut the can lid.
